(19) United States
(12) Patent Application Publication
(10) Pub. No.: US 2014/0272214 A1
(43) Pub. Date: Sep. 18, 2014

(54) ADHESIVE COMPOSTIONS WITH WIDE SERVICE TEMPERATURE WINDOW AND USE THEREOF

(71) Applicants: HENKEL CORPORATION, Rocky Hill, CT (US); HENKEL LTD., Hatfield (GB)

(72) Inventors: Richard Ellis, Buckinghamshire (GB); Geetanjaliben Shah, Somerset, NJ (US); Andrea Eodice, Hillsborough, NJ (US)

(73) Assignees: Henkel Ltd., Hatfield (GB); Henkel Corporation, Rocky Hill, CT (US)

(21) Appl. No.: 13/795,403

(22) Filed: Mar. 12, 2013

(51) Int. Cl. C09J 153/00

(52) U.S. Cl. CPC C09J 153/00
USPC 428/34.3; 524/505; 428/355 EN; 428/355 AC; 428/34.2; 428/35.2; 428/34.1

(57) ABSTRACT

The invention provides hot melt adhesives comprising (A) a mixture of polymers consisting of (1) an amorphous alpha olefin, (2) an ethylene copolymer that has a Tg value equal to or less than −35° C.; and (3) a styrene block copolymer; and (B) a polyethylene wax grafted with a functional group. These hot melt adhesives have high heat resistance and good low temperature performance, making them particularly well suited for end-of-line packaging application.

### FIELD OF THE INVENTION

The present invention relates to hot melt adhesives that have high heat resistance and good low temperature performance, making these adhesives particularly well suited for end-of-line packaging application.

### BACKGROUND OF THE INVENTION

Hot melt adhesives are applied to a substrate while in a molten state and cooled to harden the adhesive layer. The hot melt adhesives are widely used in the end-of-the-line packaging industry to seal cardboard cases, trays, bags and cartons. Depending on the environmental and transportation conditions, some packages require the hot melt adhesive to have high heat resistance (ability to maintain fiber tear at temperatures at or greater than 65° C.) and good low cold temperature performance (maintain adhesion at −10° C.).

Ethylene vinyl acetate (EVA) based hot melt adhesives are used widely in the end-of-the-line packaging applications. EVA based adhesives adhere strongly to cellulosic substrates and have fast set time; however, they have poor low temperature performances. Also, the cost of EVA polymers has been steadily rising in recent years due to supply disruptions.

An alternative polymer to the hot melt adhesive is an amorphous poly alpha olefin (APAO) polymer. APAO are abundant and are relatively inexpensive compared to EVA polymers; however, adhesives made with APAO typically have much longer set times than EVA based adhesives. Like EVA based adhesives, APAO based adhesives also have poor low temperature performances.

There is a need in the art for hot melt adhesives that possess good performances at both ends of the temperature spectrums. The current invention fulfills this need.

### BRIEF SUMMARY OF THE INVENTION

The present invention relates to a hot melt adhesives that provide wide service temperature window and to articles of manufacture comprising the same adhesive.

One aspect of the invention is directed to a hot melt adhesive comprising (A) a mixture of polymers consisting of (1) an amorphous alpha olefin, (2) an ethylene copolymer that has a Tg value equal to or less than −35° C.; and (3) a styrene block copolymer; and (B) a polyethylene wax grafted with a functional group. The adhesive has a set time of five or less seconds and an improved cold adhesion over an adhesive without any one of the components in (A) and (B).

In another aspect of the invention, the hot melt adhesive composition comprises a mixture of a polymer consisting of (1) 20-50 wt % of an amorphous alpha olefin, (2) 1-10 wt % of an ethylene copolymer with a Tg equal or less than −35° C., and (3) 1-5 wt % of a styrene block copolymer; and 1-5 wt % of a polyethylene wax grafted with a functional group. The total wt % of the adhesive is 100 wt %.

Yet another aspect of the invention is directed to a hot melt adhesive composition consisting essentially of (A) a mixtures of polymers consisting of (1) an amorphous alpha olefin, (2) an ethylene copolymer that has a Tg value equal to or less than −35° C., and (3) a styrene block copolymer; (B) polyethylene wax grafted with a functional group; (C) a tackifier; and (D) a non-functionalized wax. The adhesive has a set time of five or less seconds and an improved low temperature adhesion over an adhesive without any one of the components in (A) and (B).

Another aspect of the invention is directed to an article of manufacture comprising a cellulosic substrate and a hot melt adhesive comprising a mixture of polymers consisting of (1) an amorphous alpha olefin, (2) an ethylene copolymer that has a Tg value equal to or less than −35° C.; and (3) a styrene block copolymer; and a polyethylene wax grafted with a functional group.

### DETAILED DESCRIPTION OF THE INVENTION

In accordance with the present invention, a hot melt adhesive composition is formed comprising (A) a mixture of polymers consisting of an amorphous alpha olefin, an ethylene copolymer that has a Tg value equal to or less than −35° C., and a styrene block copolymer; and (B) a polyethylene wax grafted with a functional group. The hot melt adhesive composition may further include a tackifier, non-functionalized wax, additives.

The amorphous alpha olefin polymers (APAO) useful in the mixture of polymers consists of several different categories of atactic, low molecular weight, low melt viscosity, and essentially amorphous propylene based polymers. Essentially amorphous is to be understood as having crystallinity of less than about 10%, based on the polymer. Polymer crystallinity can be measured by x-ray diffraction or DSC (Differential Scanning calorimeter) methods. For the DSC method, heat or crystallization and/or heat of fusion are measured and the polymer crystallinity is correlated to those values. These polymers are well known to those skilled in the art and can be either homopolymers of propylene or copolymers of propylene with one or more alpha-olefin comonomer, such as, for example, C2 (ethylene), C4 (butylene), C5 (pentene), C6 (hexane), C7 (heptene), C8 (octene), C9 (nonene), C10 (decene), C11 (undecene) and C12 (dodene) olefin comonomer. The average weight molecular weight of the APAO polymers in the scope of the present invention is in the range of from about 1,000 to about 300,000 g/mol, preferably from about 10,000 to about 100,000 g/mol. The polymers advantageously have a Ring and Ball softening point between about 80 and 170° C., preferably between about 120 and 145° C., a hardness value between about 25 to 100 dm measured in accordance with ASTM D5, and a glass transition temperature from about −5 to −40° C., measured in accordance with ASTM E 28. APAO useful in the present invention has a viscosity range of about 2,000 cP to about 20,000 cP at 190° C., measured in accordance with ASTM D 3236. Although any APAO polymer falling in the range of physical properties herein described above can be used, the most preferred APAO is selected from the group consisting of propylene homopolymer, propylene-ethylene copolymer, propylene-butene-1 copolymer and propylene-ethylene-butene-1 terpolymer. The APAO polymers of the types herein described above are commercially available from Eastman Chemical Company, Kingsport, Term., under the trade name designation Eastoflex or from Huntsman Corporation, Houston, Tex., under the trade name designation Rexflex or from Degussa Corporation, Parsippany, N.J., under the trade name designation Vestoplast.

In one embodiment, the APAO is a propylene-ethylene copolymer, having a propylene content of about 55 wt % to about 95 wt %, based on the weight of the polymer.

The polymer mixture further comprises an ethylene copolymer that has a Tg value equal to or less than −35° C.

Examples include ethylene copolymers with n-butyl acrylate, n-hexyl acrylate, butene, octene, acrylic acid, and methacrylic acid. Also useful are amorphous polyalpha olefins such as atactic propylene, and ethylene copolymers with C3-C12 olefin comonomer, particularly preferred are ethylene copolymers with C4-C12 olefin comonomer. Random and block copolymers, as well as blends thereof may be used in the polymer mixture. Of the aforementioned examples, ethylene copolymers with a Tg value equal to or less than −35° C. are particularly useful for the adhesive.

Ethylene copolymer with a melt index of about 300 to about 1500 grams/10 minutes, measured in accordance with ASTM D1238, are particularly preferred for the adhesive. Mixtures of various ethylene copolymers falling within these ranges may also be used, if miscible with one another.

One preferred ethylene copolymer is an ethylene-butyl acrylate copolymer, containing from about 20 to about 50% by weight n-butyl acrylate. Such copolymers can be obtained conventionally by high-pressure radical polymerization from ethylene and from butyl acrylate (see, for example, U.S. Pat. No. 5,298,582). Commercially available ethylene-butyl acrylate copolymers include, among others, EN33330 from Elf Atochem and Enable from Exxon Chemical.

Another preferred ethylene copolymer is an amorphous poly alpha olefin with propylene comonomer, available as Affinity GA grades from Dow Chemical Company.

The ethylene copolymer is present in an amount of from about 2 wt % to about 20 wt %, more preferably from about 3 wt % to about 15 wt %, based on the total weight of the adhesive.

The adhesive in the present invention also comprises at least one linear block copolymer having the general configuration: A-B-A or A-B-A-B-A-B-. The polymer end-blocks A are non-elastomeric styrene blocks. The elastomeric mid-block B component making up the remainder of the thermoplastic elastomeric copolymer is derived from isoprene, butadiene, ethylene, propylene or mixtures thereof, which may be hydrogenated as taught, for example, in U.S. Pat. No. 3,700,633. This hydrogenation of butadiene may be either partially or substantially complete.

Typical of the linear block copolymers useful herein are the polystyrene-polybutadiene-polystyrene (SBS), polystyrene-polyisoprene-polystyrene (SIS) and e.g., polystyrene-poly(ethylenebutylene)-polystyrene (SEBS) and polystyrene-poly-(ethylenepropylene)-polystyrene (SEPS). These copolymers may be prepared using methods taught, for example, in U.S. Pat. Nos. 3,239,478; 3,427,269; 3,700,633; 3,753,936; and 3,932,327. Alternatively, they may be obtained from Shell Chemical Co. under the trademarks KRATON 1101, 1102, 1107, 1650, 1651, 1652, 1654, 1657, 4600, and 4609; from Enichem under the EUROPRENE SOL-T tradenames; and from Firestone under the tradename STEREON 840A. Mixtures of copolymers, such as blends of SBS and SIS, may also be used.

The linear block copolymer component will generally be present at a level of from about 0.5 to about 10%, more preferably from about 1 wt % to about 8 wt %, by weight of the adhesive composition.

The adhesive of the invention further comprises a polyethylene wax grafted with a functional group. This grafting process may be performed by mixing metallocene catalyzed polyethylene wax with a functionalizing component in a reactor or in an extruder. A skilled artisan understands that various functional groups may be reacted or grafted onto the backbone of the metallocene catalyzed polyethylene wax to result in a functionalized metallocene catalyzed polyethylene wax. Functional groups that can be used in the practice of the invention include, for example, acrylic acid, acetate, sulfonate, maleic anhydride, fumaric acid and citraconic anhydride. Useful functionalized metallocene catalyzed polyethylene waxes for the adhesives include, acrylic acid functionalized metallocene catalyzed polyethylene wax, acetate functionalized metallocene catalyzed polyethylene wax, sulfonate functionalized metallocene catalyzed polyethylene wax, maleic anhydride functionalized metallocene catalyzed polyethylene wax, and the like. In one embodiment the functionalized metallocene catalyzed polyethylene wax is a maleic anhydride modified metallocene catalyzed polyethylene wax. In another embodiment the functionalized metallocene catalyzed polyethylene wax is a fumaric acid modified metallocene catalyzed polyethylene wax. In a further embodiment the functionalized metallocene catalyzed polyethylene wax is a citraconic anhydride modified metallocene catalyzed polyethylene wax.

The functional groups in the functionalized metallocene catalyzed ethylene wax are typically distributed randomly throughout the wax. Particularly preferred embodiments of the adhesive of the invention will comprise a functionalized metallocene catalyzed polyethylene wax comprising from about 0.1 to about 8 wt %, particularly about 0.3 to about 5 wt %, more particularly about 0.5 to about 3 wt % of the functional group, based on the weight of the metallocene polyethylene catalyzed wax.

Functionalized metallocene catalyzed polyethylene wax suitable for the invention will have molecular weight less than 2,000 Daltons. The functionalized metallocene catalyzed polyethylene polymer is different than a functionalized modified wax. A skilled artisan understands that functionalized modified wax typically has molecular weight less than 2,000 Daltons, whereas the polymers have a molecular weight greater than 2,000 Daltons. The crystallinity of the functionalized ethylene waxes ranges from 10 to 30%. The viscosity of the functionalized metallocene catalyzed polyethylene wax ranges from 500 cP to 8,000 cP at 140° C. Suitable functionalized metallocene catalyzed polyethylenes waxes have a melt index ranging from about 500 to about 4,000 g/10 min, 190° C., 2.16 kg, preferably from about 500 to about 1750, measured in accordance with ASTM D1238. Exemplary functionalized metallocene catalyzed polyethylenes waxes include A-C 575A, A-C 573A, AC 1783, A-C 1904, A-C 1682 series from HONEYWELL®.

The functionalized metallocene polyethylene wax will typically be present in amounts of from about 0.5 wt % to 10 wt %, more preferably from about 1 wt % to about 5 wt %, based on the total weight of the adhesive.

“Tackifying resins” or “tackifiers” are added to increase autoadhesion (tack, inherent tack, self-adhesion) of the adhesive. A typical tackifier has a Ring and Ball softening points, as determined by ASTM method E28, of about 70° C. to about 180° C., more preferably about 95° C. to about 150° C.

Useful tackifying resins may include any compatible resin or mixtures thereof, such as natural and modified rosins including, for example, gum rosin, wood rosin, tall oil rosin, distilled rosin, hydrogenated rosin, dimerized rosin, resinates, and polymerized rosin; glycerol and pentaerythritol esters of natural and modified rosins, including, for example, the glycerol ester of pale, wood rosin, the glycerol ester of hydrogenated rosin, the glycerol ester of polymerized rosin, the pentaerythritol ester of hydrogenated rosin, and the phenolic-modified pentaerythritol ester of rosin; copolymers and terpolymers of natured terpenes, including, for example, styrene/terpene and alpha methyl styrene/terpene; polyterpene resins having a softening point, as determined by ASTM method E28, from about 70° C. to about 150° C.; phenolic modified terpene resins and hydrogenated derivatives thereof including, for example, the resin product resulting from the condensation, in an acidic medium, of a bicyclic terpene and a phenol; aliphatic petroleum hydrocarbon resins having a Ball and Ring softening point from about 70° C. to about 135° C.; partially hydrogenated aliphatic hydrocarbon resin; aromatic petroleum hydrocarbon resins and the hydrogenated derivatives thereof; partially aromatic hydrocarbon resins; and alicyclic petroleum hydrocarbon resins and the hydrogenated derivatives thereof. Examples of hydrogenated tackifiers particularly suitable include Escorez 5400, 5600 from Exxon Mobil Chemicals, Arkon P 100, Arkon M 100 from Arakawa and Regalite S 1100 from Eastman Chemical, and the like. Also included are the cyclic or acyclic C5 resins and aromatic modified acyclic or cyclic resins.

Preferred tackifiers are synthetic hydrocarbon resins. Included are petroleum hydrocarbon resin, hydrogenated aromatic petroleum hydrocarbon resins, aliphatic/aromatic petroleum derived hydrocarbon resins, hydrogenated aliphatic/aromatic derived hydrocarbon resins, aromatic modified cycloaliphatic resins, hydrogenated aromatic modified cycloaliphatic resins, polyterpene resins, copolymers and terpolymers of natural terpenes, natural and modified rosin, glycerol and pentaerythritol esters of natural and modified rosin, and phenolic modified terpene resins.

Non-limiting examples include aliphatic olefin derived resins such as those available from Goodyear under the Wingtack Extra trade name and the Escorez 1300 series from Exxon. A common C5 tackifying resin in this class is a diene-olefin copolymer of piperylene and 2-methyl-2-butene having a softening point of about 95° C. This resin is available commercially under the trade name Wingtack 95. Eastotac series from Eastman are also useful in the invention.

Also useful are aromatic hydrocarbon resins that are C9 aromatic/aliphatic olefin-derived and available from Sartomer and Cray Valley under the trade name Norsolene and from Rutgers series of TK aromatic hydrocarbon resins. Norsolene MI 090 is a low molecular weight thermoplastic hydrocarbon polymer having a Ring and Ball softening point of 95-105° C. and is commercially available from Cray Valley.

Alpha methyl styrene such as Kristalex 3085 and 3100 from Eastman Chemicals, Sylvares S A 100 from Arizona chemicals are also useful as tackifiers in the invention.

Mixtures of two or more described tackifying resins may be required for some adhesives.

Small quantities of alkyl phenolic tackifiers can be blended with additional tackifier agents detailed above to improve the high temperature performance of these adhesives. Alkyl phenolics added in less than 20 wt % of the total weight of the adhesive are compatible and in the proper combination increase high temperature adhesive performance. Alkyl phenolics are commercially available from Arakawa Chemical under the Tamanol tradename and in several product lines from Schenectady International.

The tackifier is will usually be present in an amount from about 20 wt % to about 60 wt %, more preferably from about 20 wt % to about 50 wt %, even more preferably from about 20 wt % to about 45 wt %, based on the total weight of the adhesive.

Non-functionalized waxes, without the grafted functional group, can be optionally added to the adhesive. When added, the non-functionalized waxes are added in an amount about 5 to about 20 wt %, based on the total amount of the adhesive. The quantity is gauged so that, on the one hand, the viscosity is reduced to the required range and, on the other hand, the adhesion or the adhesive toughness is not adversely affected.

The wax can be of natural or synthetic origin and can optionally also be in chemically modified form. Naturally occurring waxes that can be added are vegetable waxes, animal waxes, mineral waxes or petrochemical waxes. Suitable chemically modified waxes are hard waxes, such as Montan ester waxes, Sasol waxes, etc. Suitable synthetic waxes are polyalkylene waxes and polyethylene glycol waxes. Petrochemical waxes are preferably added such as petrolatum, paraffin waxes, microcrystalline waxes as well as synthetic waxes.

The adhesives of the present invention may desirably also contain at least one stabilizer and/or at least one antioxidant. These compounds are added to protect the adhesive from degradation caused by reaction with oxygen induced by, for example, heat, light, or residual catalyst from the raw materials such as the tackifying resin.

Such antioxidants are commercially available from BASF and include IRGANOX®565, 1010, 1076 and 1726 which are hindered phenols. These are primary antioxidants that act as radical scavengers and may be used alone or in combination with other antioxidants, such as, phosphite antioxidants like IRGAFOS®168 available from BASF. Phosphite antioxidants are considered secondary antioxidants and are not generally used alone. These are primarily used as peroxide decomposers. Other available catalysts are CYANOX®LTDP available from Cytec Industries and ETHANOX® 330 available from Albemarle Corp. Many such antioxidants are available either to be used alone or in combination with other such antioxidants. These compounds are added to the hot melts in small amounts, typically less than about 10 wt %, and have no effect on other physical properties. Other compounds that could be added that also do not affect physical properties are pigments, which add color, or fluorescing agents. Additives like these are known to those skilled in the art.

Stabilizers are preferably added in an amount of about 0.1 to about 3 wt %, preferably about 0.2 to about 1.5 wt %, each based on the total amount of the adhesive. In general stabilizers are incorporated in order to protect the adhesive as the end product of the process according to the invention against oxidative or thermal degradation reactions that can occur in storage and/or application. The usable stabilizers preferably include hindered phenols and/or multifunctional phenols, such as for example sulfur-containing and/or phosphorus-containing phenols. Hindered phenols are understood to mean compounds, in which at least one sterically hindered group, such as for example a tert-butyl group, is bonded to the phenol, wherein the sterically hindered groups are located especially in the ortho and/or para position to the phenolic OH group. Exemplary hindered phenols that are suitable stabilizers can be selected from the following compounds or from any of their mixtures: 1,3,5-trimethyl-2,4,6-tris(3,5-di-tert.-butyl-4-hydroxybenzyl)benzene, pentaerythritol tetrakis-(3,5-di-tert.-butyl-4-hydroxyphenyl)propionate, n-octadecyl-(3,5-di-tert.-butyl-4-hydroxyphenyl) propionate, 4,4′-methylene bis(4-methyl-6-tert.-butylphenol), 4,4′-thiobis(6-tert.-butyl-o-resol), 2,6-di-tert.-butylphenol, 6-(4-hydroxyphenoxy)-2,4-bis(n-octylthio)-1,3,5-triazine, 2,4,6-tris(4-hydroxy-3,5-di-tert.-butylphenoxy)-1,3,5-triazine, di-n-octadecyl-3,5-di-tert.-butylbenzyl phosphonate, 2-(n-octylthio)ethyl-3,5-di-tert.-butyl-4-hydroxybenzoate and sorbitol hexa-(3,3,5-di-tert.-butyl-4-hydroxyphenyl)propionate.

Further additives can be added, such as for example plasticizers, oil, crosslinking agents, fillers, nucleating agents, adhesion promoters, elastomers, colorant, rheology modifiers which are known to the person skilled in the art and can be selected from a great number of commercially available products as a function of the desired properties. Additional polymers of higher or lower molecular weight (Mw) than the degraded polypropylene (co)polymer can be added to modify the adhesive properties. These polymers can be any of the conventional hot melt polymers as described in: Paul C W (2002) Hot Melt Adhesives in: Chaudhury M and Pocius A V (ed) Surfaces, Chemistry and Applications: Adhesion Science and Engineering, Elsevier Science B. V., The Netherlands pp 711-757.

The adhesive compositions of the present invention are prepared by blending the components in the melt at a temperature of above about 300° F. (150° C.), particularly above about 400° F. (200° C.), until a homogeneous blend is obtained. Various methods of blending are known in the art and any method that produces a homogeneous blend is satisfactory. For example, a Cowles stirrer provides effective mixing for preparing these compositions.

The adhesive compositions of the present invention typically have a viscosity range of about 600 cP (centipoise) to about 3000 cP at 160° C.-180° C., without any phase separation.

The hot melt adhesives of the present invention are particularly useful in case sealing applications where high heat resistance in addition to cold resistance is important, i.e., in hot filled packaging applications; e.g. sealing and closing operations for cartons, cases, bags, or trays used in packaging molten cheese, ice creams, yogurt or freshly baked goods which are subsequently subjected to refrigeration or freezing, and for corrugated cases, which are often subjected to high stresses and adverse environmental conditions during shipping and storage.

It is surprising that a combination of an APAO, a low Tg ethylene copolymer, a styrene block copolymer and a functionalized polyethylene wax copolymer results in a single phase and wider use window at both ends of the temperature spectrum. Moreover, the inventive adhesive has a fast set time of five or fewer seconds despite the fact that the primary component of the adhesive is an APAO polymer without any EVA polymer.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

### EXAMPLES

Sample preparation: Examples and Comparative Examples were prepared by combining the polymer components together around 400° F., and then adding the rest of the components, until the mixture became homogeneous.

The tackifier is Arkon M100 (from Arakawa).

The non-functionalized wax is Licoene 4201 (polyethylene wax from Clariant), Viscowax H1 (from Salsol) or a mixture thereof.

Antioxidant is Irganox 802 (BASF), Irganox 1010 (BASF), Irgaphos 168 (BASF) or a mixture thereof.

There are various known methods to measure Tg values of the polymer, and is commonly measured in accordance with ASTM D3418, with a heating rate of 10° C./min. The Tg values of the ethylene copolymers were either measured with the above described method or were cited from the TDS of the copolymers.

Appearance of the adhesives were visually observed and recorded.

Viscosity of the samples were measured at 170° C. and/or 180° C. using Brookfield Thermosel viscometer using a No. 27 spindle.

Thermal stability was tested by leaving a 50 g sample in a glass jar with diameter of 4 cm at 180° C. for 72 hours. Any discoloration, phase separation or specks/globs of separations were recorded as observation.

Heat stress, defined as the temperature at which a stressed bond fails, was measured by forming a composite construction of adhesive (W compressed) between two pieces of corrugated paperboard of 2″×4″ and 2″×6″. At least three test samples were prepared for the test. The test samples were conditioned at room temperature for 24 hours. The adhesive bead forming this composite was then placed under approximately 100 grams of cantilever stress for 24 hours at specific temperatures. The highest temperature at which the adhesive passed the heat stress was recorded.

Heat resistance, based on at least four samples, was measured by in the same methodology described in U.S. Pat. No. 8,076,407:
1. Four pieces of board 75 mm×25 mm and 75 mm×50 mm were cut from corrugated board with the fluting running parallel to the longest edge. On both sides of board a line was drawn 25 mm from the ends.
2. Approximately 100 g of hot melt in a small metal container was heated at the application temperature.
3. The adhesive was stirred with a spatula to ensure even heat distribution, the spatula was then lifted out of the adhesive to produce a stream of adhesive in the container. This process was repeated for each sample.
4. The 50 mm board is passed under the stream of adhesive to give a bead width of 3 mm along the 25 mm line (the speed with which the board is moved will determine the bead width).
5. The 25 mm board was taken and bonded same side to same side lining up 25 mm mark to that of 50 mm board's 25 mm mark. The 25 mm board is positioned in the center of the 50 mm board leaving uncompressed hot melt adhesive either side, this uncompressed adhesive once cooled can be used to check that the bead width is +4 mm.
6. The bond is formed within 3 sec and a 100 g weight placed on the bond area to ensure even bonding pressure. The bond was left at least 24 hours before testing.
7. The 25 mm board end of the bonded sample was hole-punched to allow a 100 g weight to be hung from it. The sample was attached by the 50 mm piece of board in an oven so that it was horizontal to the oven shelf with the 25 mm board facing down using three bulldog clips and a 100 weight was attached to the sample.
8. The oven was turned on and set at a temperature of 40° C. (or 130° F.) and left for 20 min. The oven temperature after the initial 20 minutes was raised by 3° C. (or 5° F.) every 15 minutes. The oven temperature noted when the sample fails represents the heat resistance of the sample.

Adhesion was measured on Kraftliner substrates at the noted temperatures in the tables. A ½″ wide bead of adhesive was applied at 170-180° C. to a 2″×3″ piece of double fluted corrugate board, and was immediately brought in contact with a second piece of corrugated to form a bond. A 200 gram weight was immediately placed on the top of the bond for 10 seconds to provide compression. The prepared boards were conditioned at room temperature for 24 hours and then further conditioned at noted temperatures in the table for 24 hours. The bonds were separated by hand and the resulting fiber tear was recorded (higher values indicated better adhesion). Fiber tear was calculated as the amount of fiber left on the surface of the adhesive, which indicates failure within the substrate and not at the interface between the adhesive and the substrate. Three specimens were tested to obtain the average percent fiber tear. It is desirable to have deep fiber tears for it demonstrates good wet-out of the adhesive at the bond line; and shallow tears and cold cracking at the adhesive interfaces are less desirable.

Set time of the adhesive was measured at 160° C. or 170° C. using Kanebo Bond, Model ASM-15N.

Open time (OT) was also measured using Kanebo Bond Tester, Model ASM-15N.

Hot tack was measured at 1 second using Kanebo Bond Tester, Model ASM-15N, in kilogram force (Kgf).

Creep for 30 second hold was measured by Kanebo Bond Tester, Model ASM-15N.

Example samples were prepared with the components listed in the Table 1. The properties of Control X, a reference standard adhesive (TS 100, Henkel Corporation), were also measured for comparative purpose.

TABLE 1

| | TS 100-control X | Ex 1 | Ex 2 | Ex 3 |
|---|---|---|---|---|
| Eastoflex 1045 | — | 33 | 33 | 33 |
| PL | | | | |
| Kraton G 1657 | — | 4 | 2 | 5 |
| Enable 33-900 | — | 7 | 9 | 10 |
| (Tg = −44° C.) | | | | |
| AC 575 | — | 2.5 | 2.5 | 3 |
| Tackifier | | 29 | 29 | 29 |
| Wax | | 24 | 24 | 20 |
| antioxidant | — | 0.8 | 0.8 | 0.6 |
| Appearance | — | Clear | Clear | Clear |
| Viscosity cPs@ | — | 1267 | 1020 | 2063 |
| 170° C. | | | | |
| ViscositycPs@ | — | 990 | 795 | 1603 |
| 180° C. | | | | |
| Thermal stability | — | Turned dark | Turned dark | Turned dark |
| at 180° C./90 hrs | | but no | but no | but no |
| | | phasing or | phasing or | phasing or |
| | | specks | specks | specks |
| Average heat | 64.8 | 71.5 | 69.3 | 67.8 |
| resistance (4) | | | | |
| Set time/s | 3.0-3.5 | 4.0-4.5 | 4.5-5.0 | 4.0-4.5 |
| (170° C.) | | | | |
| Adhesion at RT | 100, 100, 100 | 100, 100, 100 | 100, 100, 100 | 100, 100, 80 |
| Adhesion at 5° C. | 100, 100, 100 | 100, 100, 100 | 100, 100, 100 | 100, 100, 100 |
| Adhesion at −10° C. | 100, 100, 50 | 100, 100, 60 | 100, 100, 60 | 100, 100, 100 |

Examples 1-3 were clear without any phase separations, and had acceptable viscosities for application at 170-180° C. The average heat resistance values of Examples 1-3 were higher than Control X. Also, the set time was below five seconds. Examples 1-3 had better adhesion to Kraftliners at lower temperatures than Control X.

Comparative Sample adhesives, where at least one component to the polymer mixture or the functionalized polyethylene was omitted from the adhesive, are listed in Table 2. Adhesive properties of the comparative samples and listed in Table 2.

TABLE 2
Comparative Sample Adhesives

| | C Ex A | C Ex B | C EX C | C EX D | C Ex E |
|---|---|---|---|---|---|
| Eastoflex 1045 | 33 | 33 | 30 | 33 | 34 |
| PL | | | | | |
| Kraton G 1657 | 0 | 5 | 3 | 2 | 5 |
| Enable 33-900 | 10 | 0 | 0 | 9 | |
| EVA 28-800 | | | 7.5 | | |
| (Tg = −20° C.) | | | | | |
| AC 596 | | | | | 1 |
| AC 575 | 3.5 | 3 | | 0 | |
| Tackifier | 29 | 29 | 35 | 29 | 30 |
| Wax | 24 | 30 | 24.5 | 24 | 30 |
| antioxidant | 0.8 | 0.6 | 0.6 | 0.8 | 0.6 |
| Appearance | Clear | Clear | slightly | clear | Clear |
| | | | hazy | | |
| Viscosity cPs at | 732 | 1045 | 990 | 564 | 956 |
| 170° C. | | | | | |
| Thermal stability | Turns dark | N/A | phase | N/A | No char and |
| at 180° C./90 hrs | but no | | separated | | no gelling |
| | phasing or | | | | |
| | specks | | | | |
| Average heat | 63.5 | 69.25 | | 69.25 | 64 |
| resistance (4) | | | | | |
| Set time/s | 6.0-7.0 | 4.5-5.0 | | 5.0-5.5 | 4.0-4.5 |
| (170° C.) | | | | | |
| Adhesion at RT | 100, 100, 100 | 100, 100, 100 | | 100, 100, | 100, 50, 0 |
| | | | | 100 | |
| Adhesion at 5° C. | 100, 10, 0 | 0, 80, 30 | | 100, 100, | 0, 0, 0 |
| | | | | 100 | |
| Adhesion at −10° C. | 0, 0, 0 | 0, 0, 0 | | 0, 0, 40 | 0, 0, 0 |

Comparative Example A, without a SBS block copolymer, resulted in poorer heat resistance performance than Control X, longer than 5 second set time, and poorer low temperature performance.

Comparative Example B, without a low Tg ethylene copolymer, also resulted in poor low temperature performance.

Comparative Example C, replacing the low Tg ethylene copolymer with an EVA polymer, resulted in phase separation of the adhesive, which is not desirable for a packaging adhesive.

Comparative Example D, without the functionalized polyethylene wax, resulted in unacceptable set time (greater than 5 seconds) and low adhesion at −10° C.

The substitution of the functionalized polyethylene wax with a functionalized polypropylene wax in Comparative Example E also resulted in loss of adhesion at low temperatures.

The deficiency of one of the components to the polymer mixture or the functionalized polyethylene wax resulted in an adhesive with inferior performances, especially at −10° C. adhesion.

Several ethylene copolymers with varying Tg values were used in the adhesive samples and their properties were measured. The base sample consisted of 33 parts ethylene-propylene copolymer, 4 parts SEBS triblock copolymer, 2.5 parts maleic anhydride functionalized polyethylene wax, 29 parts hydrocarbon tackifier, 24 parts wax and 0.8 parts antioxidant. Into the base sample, 7 parts of an ethylene or propylene copolymer with varying Tg values was added, as shown in Table 3. Adhesive properties were measured for the comparative samples and are also listed in Table 3.

TABLE 3

| | Ex 4 | C Ex F | C Ex G | C Ex H |
|---|---|---|---|---|
| Affinity 1950 (Tg = −58° C.) | 7 | | | |
| Rextac-2315 (Tg = −26° C.) | | 7 | | |
| Rextac-2732 (Tg = −19° C.) | | | 7 | |
| Rextac-2330 (Tg = −24° C.) | | | | 7 |
| Viscosity at 177° C. | 1210 | 685 | | |
| Adhesion at −29° C. | 100, 80, 70d | 90, 50, 70cc d | 90, 40, 80cc d | 85, 60, 60cc |
| Adhesion at −18° C. | 100, 80, 90d | 80, 40, 40d-sh | 90, 50, 70cc d | 70, 40, 40cc |
| Adhesion at −6.7° C. | 100, 90, 90s | 90, 40, 60d-sh cc | 80, 80, 80d | 85, 40, 0cc |
| Adhesion at 4.4° C. | | 80, 80, 40d | 80, 70, 90d | 20, 80, 70cc d sh |
| Adhesion at RT | 100d all | 100d all | 100d all | 100d all |
| Adhesion at 57° C. | 100, 90, 95d | 100, 100, | 100, 80, 90d | 90, 100, 90d |
| | | 90d | | |
| Heat stress | | | | |
| 135 F (275° C.) | 3P | 3P | 2P | 3P |
| 140 F (284° C.) | | 3P | 3P | |
| Kanebo | | | | |
| Hot tack - 1 sec (Kgf) | 5.65 | 5.75 | 5.95 | 5.8 |
| Set time/s | 4.5-5.0 | 3.5-4.0 | 4.5-5.0 | 3.5-4.5 |
| Open time/s | 7-8 | 7-8 | 7-8 | 7-8 |
| Creep for 30 sec hold (s) | 16 | 15 | 18 | 15 |

*cc = cold cracking at the adhesive interface
**d = deep fiber at the adhesive interface
***sh = shallow tear at the adhesive interface

The adhesion and heat stress at higher temperatures were similar for all samples listed in Table 3. Also, all the samples in Table 3 had a set time of 5 seconds or less. Only Adhesive Example 4 had superior adhesion at low temperature than the other comparative adhesives formed with polymers with Tg value higher than −35° C. Thus, the adhesive formed with an ethylene copolymer that has a Tg value less than −35° C. had better performance at lower temperatures, and widened the service window of the adhesive.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

I/We claim:

1. A hot melt adhesive composition comprising:
(A) a mixture of polymers consisting of
(1) an amorphous alpha olefin;
(2) an ethylene copolymer that has a Tg value equal to or less than −35° C.; and
(3) a styrene block copolymer; and
(B) a polyethylene wax grafted with a functional group;
wherein the adhesive has a set time of five or less seconds and wherein the adhesive has an improved cold adhesion over an adhesive without any one of the components in (A) or (B).

2. The hot melt adhesive composition of claim 1, wherein
(A) the mixture of the polymer consists of:
(1) 20-50 wt % of the amorphous alpha olefin;
(2) 1-10 wt % of the ethylene copolymer; and
(3) 1-5 wt % of the styrene block copolymer; and
(B) 1-5 wt % of the polyethylene wax grafted with a functional group;
wherein the total wt % of the adhesive is 100 wt %.

3. The hot melt adhesive composition of claim 1, wherein the amorphous alpha olefin is polypropylene copolymer with C2, C4, C5, C6, C7, C8, C9, C10, C11 or C12 olefin comonomer.

4. The hot melt adhesive composition of claim 3, wherein the polypropylene copolymer has a propylene content of about 55 to about 95 wt %, based on the copolymer, has a crystallinity of less than about 10%, and has a viscosity range of about 2,000 to about 20,000 cP at 190° C., measured in accordance with ASTM D1238.

5. The hot melt adhesive composition of claim 1, wherein the ethylene copolymer is a butyl acrylate random copolymer with a butyl acrylate content of about 20 to 40 wt % and a MI of about 500 to 1500 at 190° C., in accordance with ASTM D1238.

6. The hot melt adhesive composition of claim 1, wherein the ethylene copolymer is copolymerized with C4, C5, C6, C7, C8, C9, C9, C10, C11 or C12 olefin comonomer.

7. The hot melt adhesive composition of claim 6, wherein the ethylene copolymer is a metallocene catalyzed ethylene-octene with a polydispersity of about 1 to about 3.

8. The hot melt adhesive composition of claim 1, wherein the styrene block copolymer is selected from the group consisting of linear blocks of SIS, SIBS, SEBS, and mixtures thereof.

9. The hot melt adhesive composition of claim 1, wherein the functional group of the polyethylene wax grafted with functional group is selected from the group consisting of fumaric acid, acrylic acid, acetate, sulfonate, citraconic anhydride and maleic anhydride.

10. The hot melt adhesive composition of claim 1 further comprising a tackifier selected from the group consisting of petroleum hydrocarbon resin, hydrogenated aromatic petroleum hydrocarbon resins, aliphatic/aromatic petroleum derived hydrocarbon resins, hydrogenated aliphatic/aromatic derived hydrocarbon resins, aromatic modified cycloaliphatic resins, hydrogenated aromatic modified cycloaliphatic resins, polyterpene resins, copolymers and terpolymers of natural terpenes, natural and modified rosin, glycerol and pentaerythritol esters of natural and modified rosin, phenolic modified terpene resins and mixtures thereof.

11. The hot melt adhesive composition of claim 1 further comprising a non-functionalized wax selected from the group consisting of Fischer-Tropsch, paraffin, polyethylene wax, microcrystalline wax and mixtures thereof.

12. The hot melt adhesive composition of claim 1 further comprising one or more of an antioxidant, stabilizer, crosslinking agent, filler, nucleating agent, adhesion promoter, elastomer, colorant, rheology modifier and mixtures thereof.

13. A hot melt adhesive composition consisting essentially of:
(A) a mixtures of polymers consisting of
(1) an amorphous alpha olefin;
(2) an ethylene copolymer that has a Tg value equal to or less than −35° C.; and
(3) a styrene block copolymer; and
(B) polyethylene wax grafted with a functional group;
(C) a tackifier; and
(D) a non-functionalized wax;
wherein the adhesive has a set time of five or less seconds and
wherein the adhesive has an improved cold adhesion over an adhesive without any one of the components in (A) or (B).

14. The hot melt adhesive composition of claim 13,
wherein the amorphous propylene-ethylene copolymer has a propylene content of about 55 to about 95 wt %;
wherein the ethylene copolymer is a butyl acrylate random copolymer or an ethylene-octene; and
wherein the styrene block copolymer is a styrene-ethylene-butylene-stryrene block copolymer.

15. An article comprising a substrate and an adhesive composition consisting essentially of:
(A) a mixtures of polymers consisting of:
(1) an amorphous alpha olefin;
(2) an ethylene copolymer that has a Tg value equal to or less than −27° C.; and
(3) a styrene block copolymer;
(B) polyethylene wax grafted with a functional group;
(C) a tackifier; and
(D) a non-functionalized wax;
wherein the adhesive has a set time of five or less seconds on the substrate and wherein the adhesive has an improved cold adhesion over an adhesive without any one of the components in (A) or (B).

16. The article of claim 15 wherein the substrate is a paper, paperboard, chipboard or film.

17. The article of claim 16,
wherein the amorphous propylene-ethylene copolymer has a propylene content of about 55 to about 95 wt %;
wherein the ethylene copolymer is a butyl acrylate random copolymer or an ethylene-octene; and
wherein the styrene block copolymer is a styrene-ethylene-butylene-styrene block copolymer.

18. The article of claim 16 which is a case, carton, box, bag or tray.
